(19) United States
(12) Patent Application Publication
(10) Pub. No.: US 2003/0179052 A1
(43) Pub. Date: Sep. 25, 2003

(54) MULTIPLE CHANNEL ROUTING MULTIPLEXER

(76) Inventors: James D. Sawdey, Dublin, CA (US); Stephen Holme, San ramon, CA (US)

Correspondence Address: J.E. Kosinski, Loral Space & Communications, Ltd., Suite 303, 655 Deep Valley Drive, Rolling Hills Estates, CA, 90274, US

(21) Appl. No.: 10/103,586

(22) Filed: Mar. 20, 2002

(51) Int. Cl. H01P 5/12

(52) U.S. Cl. 333/135

(57) ABSTRACT

A multiplexer has a plurality of manifolds interconnected by bandpass filters of differing spectral passbands. The filters serve to segregate signal channels from each other during a process of separating microwave signals in one of the manifolds and in a process of combining the microwave signals associated with another of the manifolds. A compact rigid structure of reduced mass is attained by employing one or more of the bandpass filters as connecting filters for coupling a signal channel directly between a first of the manifolds and a second of the manifolds, wherein the construction of the manifold and the connecting filters is in the form of a rigid assembly. A base may be provided for supporting each of the manifolds and each of the bandpass filters in a unitary structure.

### BACKGROUND OF THE INVENTION

This invention relates to a separation and a combination of electromagnetic signals and a multiplexer suitable for use in a satellite and a system for communication via satellite and, more particularly, to a multiplexer for accomplishing the foregoing functions in a unitary structure of reduced size and mass.

In a satellite carrying communication equipment for the processing of signals of numerous channels of a communication system, the communication equipment may have the task of arranging a set of received uplink signals to produce a set of downlink signals for transmission by antenna elements to different geographic locations. This is accomplished by the separation of various signal channels of the received uplink signals, and the combining of various ones of the separated channels to produce a desired set of channels for transmission to a geographic location. Such separation and combining has been accomplished at microwave frequencies by use of multiplexers which include manifolds operative with bandpass filters that serve to segregate the respective signal channels. Previous designs of multiplexer units (input, combining or output) have accommodated the separation of signals into separate channels or subgroups of channels or the combining of multiple signals or signal groups. This has been accomplished by use of separate units to combine some channels while separating other channels, wherein routing from one input signal path to a choice of output paths and routing multiple input paths to a single output path have been implemented with separate devices. Such separate assemblies of microwave equipment tend to be bulky and heavy, thus presenting the disadvantage of necessitating a design of the satellite to carry a larger and a heavier payload than is desirable.

### SUMMARY OF THE INVENTION

The aforementioned disadvantage is overcome and other benefits are provided by a multiplexer forming a multiple channel routing multiplexer wherein, in accordance with the invention, a plurality of manifolds are interconnected by bandpass filters. The filters serve to segregate signal channels from each other during a process of separating the microwave signals associated with various ones of the channels found in one of the manifolds. The filters also serve to segregate signal channels from each other during a process of combining the microwave signals associated with various ones of the channels by use of another of the manifolds.

In accordance with a feature of the invention, one or more of the bandpass filters are employed as connecting filters for coupling a signal channel directly between a first of the manifolds and a second of the manifolds, wherein the construction of the manifold and the connecting filters is in the form of a rigid assembly which replaces the numerous separate assemblies of the prior art. The rigid assembly of manifolds and filters in the multiplexer of the invention is more compact and of reduced mass as compared to the system of numerous separate assemblies of the prior art.

As an example in the construction of a preferred embodiment of the invention, there is provided a first manifold serving as an input manifold and having an input port for receiving a plurality of signals in differing spectral bands, and a plurality of output ports respectively for outputting signals in differing spectral bands. There is provided a second manifold and a third manifold each serving as an output manifold and having an output port for outputting a plurality of signals in differing spectral bands, and a plurality of input ports respectively for receiving signals in differing spectral bands. Bandpass filters, each having differing fixed spectral passbands, provide for connection of output ports of the first manifold to input ports of the second and the third manifolds as well as for segregating signal channels of further output ports of the first manifold. The bandpass filters also provide for receiving input signals at input ports of each of the second and the third manifolds. A base may be provided for supporting each of the manifolds and each of the bandpass filters in a unitary structure.

By way of further example in the construction of the foregoing embodiment of the invention, each of the bandpass filters comprises a cylindrical sidewall terminated by opposed end walls defining a resonant cavity. Each of the manifolds is constructed as a section of waveguide of rectangular cross-section having a pair of broad sidewalls connected by a pair of opposed narrow sidewalls. A sidewall, preferably a broad sidewall of a manifold is suitable for the rigid mounting of a filter thereon with the end wall of the cavity in contact with the side wall of the manifold. If desired, at a location of connection between a cavity and a manifold, the sidewall of the manifold may serve as the end wall of the cavity. At the location of connection between the bandpass filter and the manifold there is electromagnetic coupling between the bandpass filter and the manifold via a slot extending through the end wall of the filter and the sidewall of the manifold. The filters may include tuning elements, may have single or multiple cavities, and may include mode coupling elements for generating plural modes of electromagnetic waves within a filter cavity.

The invention provides for a reconfiguration of multiple input channels into multiple output channels with minimization of mass and insertion loss within the routing configuration. Minimization of mass, along with a compact assembly, occurs in the routing assembly by use of a single filter providing both the function of separating signals and the function of combining signals. A concept of the invention is to integrate filtering and multiplexing functions normally performed by separate assemblies. The assembly of the invention allows for the separation of multiple signals, each having its own carrier frequency, from one signal path for routing on separate paths, and the combining of other signals from separate paths to be combined for a single output. The routing multiplexer filtering concept allows the combining of multiple input paths and the creation of multiple output paths consisting of a different combination of input and output signal groups or groups of channels.

### BRIEF DESCRIPTION OF THE DRAWING

The aforementioned aspects and other features of the invention are explained in the following description, taken in connection with the accompanying drawing figures wherein:

FIG. 1 shows diagrammatically a multiple channel routing multiplexer of the invention serving as part of a communication system with communication via a satellite link;

FIG. 2 is a stylized perspective view of the multiplexer of FIG. 1;

FIG. 3 is a fragmentary stylized perspective view showing detail in the interconnection of a filter between manifolds in the multiplexer of FIGS. 1 and 2; and

FIG. 4 is a stylized perspective view of an alternative embodiment of a bandpass filter having dual mode operation in the multiplexer of FIGS. 1 and 2.

Identically labeled elements appearing in different ones of the figures refer to the same element but may not be referenced in the description for all figures.

### DETAILED DESCRIPTION OF THE INVENTION

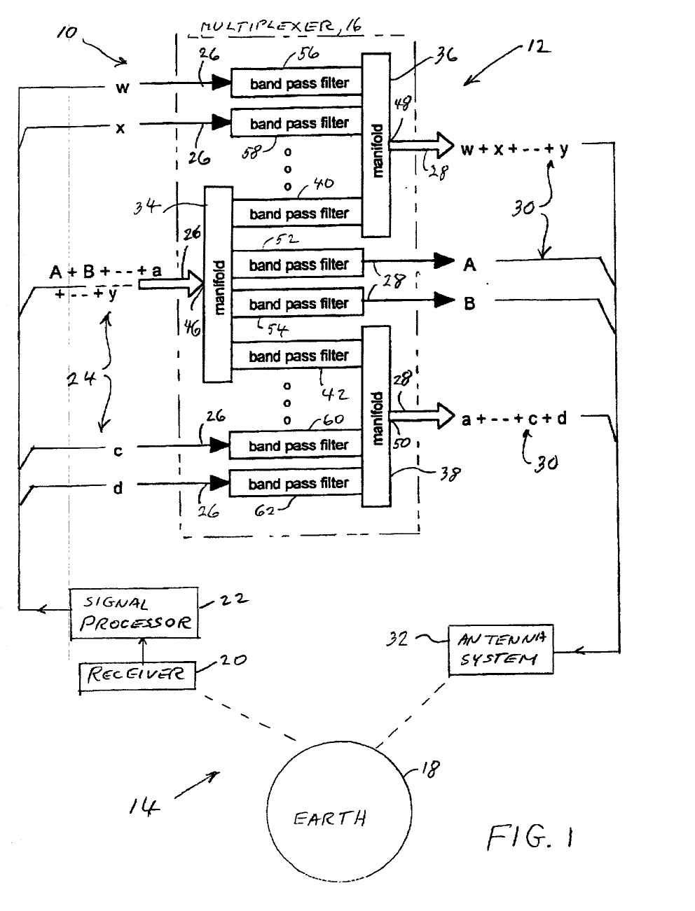

FIG. 1 presents electronic equipment 10 carried by a satellite 12 and forming part of a communication system 14. Included within the equipment 10 is a multiplexer 16 constructed in accordance with the invention. In the operation of the equipment 10, signals communicate via an uplink channel from the earth 18 to the satellite 12, and are received by a receiver 20 followed by processing in a signal processor 22. Various well-known signal-processing functions may be performed by the processor 22. An additional function of routing the signals is provided by the multiplexer 16. The processor 22 outputs to the multiplexer 16 a set of microwave signals disposed in separate signal channels 24 on separate carrier frequencies. The multiplexer 16 receives the signals via a set of input ports 26 of the multiplexer 16, and outputs the signals via a set of output ports 28 of the multiplexer 16. By way of example in the implementation of the satellite electronic equipment 10, the output ports 28 of the multiplexer 16 apply their respective output signals in channels 30 to various components, such as feed elements, of an antenna system 32 which, in turn, produces a set of beams directing various output signal channels 30 and to corresponding locations on the earth's surface.

As shown in FIGS. 1, 2 and 3, the multiplexer 16 comprises a plurality of manifolds of which three manifolds 34, 36 and 38 are shown by way of example. The plurality of manifolds are interconnected by a plurality of the bandpass filters of which two interconnecting bandpass filters 40 and 42 are shown by way of example. The filter 40 interconnects the manifold 34 with the manifold 36, and the filter 42 interconnects the manifold 34 with the manifold 38. In accordance with a feature of the invention, the assembly of the three manifolds 34, 36 and 38 with their interconnecting bandpass filters 40 and 42 constitute a rigid unitary assembly wherein, if desired, the rigidity may be enhanced by a mounting of the manifolds to a supporting base plate 44. The manifold 34 has an input port 46 which also serves as one of the input ports 26 of the multiplexer 16. The manifold 36 has an output port 48 it also serves as one of the output ports 28 of the multiplexer 16. The manifold 38 has an output port 50 which also serves as one of the output ports 28 of the multiplexer 16. Two bandpass filters 52 and 54 connect to output ports of the manifold 34, and to serve to output signals from the multiplexer 16 via output ports 28. Two bandpass filters 56 and 58 connect to input ports of the manifold 36, and serve to receive signals for the multiplexer 16 via input ports 26. Two bandpass filters 60 and 62 connect to input ports of the manifold 38, and serve to receive signals for the multiplexer 16 via input ports 26.

It is noted that the use of the terms input port and output port is intended to facilitate the description of the invention, and conforms to the direction of signal flow shown in FIG. 1. However, is to be understood that the components of the multiplexer 16, namely, the manifolds and the bandpass filters of the multiplexer 16, operate in reciprocal fashion such that signals could be inputted via the output ports 28 to exit via the input ports 26 of the multiplexer 16.

Each of the manifolds 34, 36 and 38 is constructed of a section of waveguide which, by way of example, is shown as a waveguide of rectangular cross-section having four sidewalls consisting of opposed broad walls 64 and 66 joined by narrow walls 68 and 70. Furthermore, by way of example in the construction of any one of the manifolds 34, 36 and 38, the section of waveguide is terminated by an end wall 72 at one end of the waveguide section, and at an opposite and thereof is open for formation of a port such as the port 46, 48 or 50. The sidewalls and the end wall in each of the manifolds is constructed of an electrically conducting material such as copper.

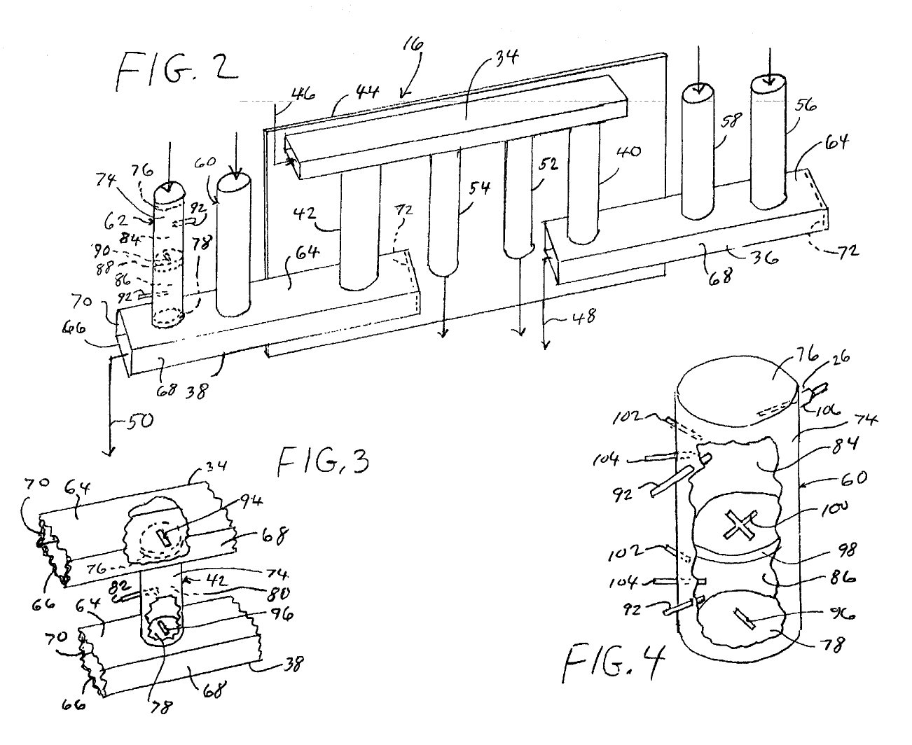

Each of the bandpass filters 40 and 42, as well as other ones of the bandpass filters has a cylindrical form, such as a right circular cylinder by way of example, and comprises a cylindrical sidewall 74 terminated by opposed end walls 76 and 78 that define a cavity 80 (as shown for the filter 42 in FIG. 3). The sidewalls and the end wall in each of the filters is constructed of an electrically conducting material such as copper. The cavity 80 resonates as a frequency of microwave radiation dependent on the dimensions of the cavity 80 and on the position of a tuning element, such as a tuning screw 82 which extends through the sidewall 74 into the cavity 80. Rotation of the screw 82 advances the screw 82 to a desired position for adjustment of the resonant frequency of the cavity 80. The construction of the filter 42 with a single cavity 80 is presented by way of example, it being understood that a filter, such as the filter 62 (as shown in FIG. 2) may be constructed of two cavities 84 and 86 separated by a transverse wall 88. The transverse wall 88 has a coupling aperture 90 having the configuration of a linear slot. Each of the cavities 84 and 86 is provided with a tuning screw 92, disposed in the sidewall 74, for adjustment of resonant frequency in the cavity.

In FIG. 3, portions of the sidewalls of the manifold 34 and of the filter 42 have been cut away to show a mode of coupling of electromagnetic energy between the manifold 34 and the filter 42, and between the filter 40 to the manifold 38. At the interface between the filter 42 and the manifold 34, electromagnetic energy is coupled by way of a linear slot 94 extending from the cavity 80 through the end wall 76 and the broad wall 64 to the interior space of the manifold 34. At the interface between the filter 42 and the manifold 38, electromagnetic energy is coupled by way of a linear slot 96 extending from the cavity 80 through the end wall 78 and the broad wall 66 to the interior space of the manifold 38. The slot 94 extends perpendicularly to the longitudinal direction of the manifold 34, and the slot 96 extends perpendicularly to the longitudinal direction of the manifold 38. The coupling by means of slots, such as the slots 94 and 96 depicted in FIG. 3 at the interfaces between the bandpass filter 42 and the manifolds 34 and 38, is employed also for other ones of the interfaces at various ones of the bandpass filters with respective ones of the manifolds depicted in FIG. 2. By way of alternative embodiment in the construction at the interface between a filter and a manifold, such as the interface between the filter 62 and the manifold 38, the broad wall 64 can serve as the end wall 78 wherein the sidewall 74 contacts the broad wall 64, thereby simplifying construction by omitting the additional wall 78.

FIG. 4 shows, by way of example in an alternative construction of bandpass filter, a construction of the bandpass filter 62 of two cavities 84 and 86 separated by a transverse wall 98. The transverse wall 98 has a coupling aperture 100 in the configuration of a crossed slot for the coupling of electromagnetic energy between the cavities 84 and 86. By way of comparison of the operation of the filter 60 with the filter 62, in the filter 62 the two cavities 84 and 86 each operate with a single mode of vibration of electromagnetic wave, and only the single tuning screw 92 is in each of the cavities 84 and 86 for tuning the respective cavity. However, in the filter 60, each of the cavities 84 and 86 supports two orthogonal modes of vibration of electromagnetic wave and, accordingly, the tuning screw 92 tunes one of the electromagnetic waves in a respective one of the cavities, and an additional tuning screw 102 is provided for each of the cavities 84 and 86 for tuning the orthogonal wave. A mode coupling screw 104 is also provided in each of the cavities 84 and 86 of the filter 60 for the coupling of electromagnetic energy between the two modes. In the filter 62, the linear slot of the coupling aperture 90 suffices to communicate electromagnetic energy between the single modes of vibration in the two cavities while, in the filter 60, the crossed slot of the coupling aperture 100 serves to communicate electromagnetic energy between the dual orthogonal modes of vibration in the two cavities. With respect to the filter 60, the manifold input ports 26 may be constructed, by way of example, as a coaxial connector 106 with a post or loop extending through the sidewall 74 into the cavity 84. Alternatively, a waveguide connection (not shown) can be employed at the input port 26.

In the operation of the multiplexer 16, and with reference to FIG. 1, the input signals may be the signals of either single input channels or groups of channels to be routed as output signals by different outputs via single channels or groups of channels. All signals are input either through an input multiplexer type of configuration (manifold or other splitting network) or are output through an output multiplexer type of configuration (manifold or other combining network), or both. Input signals to be routed as a group (or single channel) are filtered and are combined with other signals in an output manifold or combining device. Other signals connect to filters through a manifold or separation network and then pass through grouping or isolation filters. These latter signals are then either combined with other signals in an output combining device or are output directly through a filter.

In the general configuration for a routing multiplexer, as depicted in FIG. 1, the input signals (c, d, w, x) are provided in single input channels. Input signal (A+B++a++y) is a group of channels to be routed to different outputs. The capitalization of the letters identifying some of the signals indicates that the signals (A, B) in a single channel will be divided out in separate channels, while the lower case letters identifies signals that will be combined with other signals before being outputted. On the output side, the signals of single channels A and B are separated from other input signals in an input multiplexer configuration, and are output directly to other elements of a payload, such as the antenna system 32. Grouping signal channels and subgroups of channels in output manifolds (such as w+x++y and z++c+d) creates other output signals.

The benefit of a routing multiplexer, such as the multiplexer 16, is the improvement in mass and size, and performance associated with implementation in a single device. Mass and size are minimized by implementation of a single filtering component with appropriate manifolds to perform the separation function and the combining function. This eliminates a need for interconnection of coax or waveguide and the use of an additional filter. Performance is also improved in terms of the benefit of reduced insertion loss associated with a single filter and an absence of interconnecting cabling harness. The integration of microwave components into a single unit also insures unit performance with tuning and verification at the unit level, and simplifies testing of the nultiplexer.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A multiplexer comprising:
a first manifold having an input port for receiving a plurality of signals in differing spectral bands, and a plurality of output ports respectively for outputting signals in differing spectral bands;
a second manifold having an output port for outputting a plurality of signals in differing spectral bands, and a plurality of input ports respectively for receiving signals in differing spectral bands;
a set of bandpass filters having differing spectral passbands, said set of bandpass filters including a first plurality of filters connected respectively to the output ports of said first manifold, said set of bandpass filters including furthermore a second plurality of filters connected respectively to the input ports of said second manifold; and
wherein at least one filter of said set of bandpass filters serves as a connection filter for connecting an output port of said first manifold with an input port of said second manifold, said connection filter being rigidly secured to each of said first manifold and said second manifold to form a unitary structure of said first manifold and said second manifold with said connection filter.

2. A multiplexer according to claim 1 further comprising a third manifold having an output port for outputting a plurality of signals in differing spectral bands, and a plurality of input ports respectively for receiving signals in differing spectral bands via a third plurality of filters of said set of bandpass filters, wherein a second filter of said set of bandpass filters serves as a second connection filter for connecting a second output port of said first manifold with an input port of said third manifold, said second connection filter being rigidly secured to each of said first manifold and said third manifold to form a unitary structure of said first and said second connection filters with said first, said second and said third manifolds.

3. A multiplexer according to claim 2 wherein each of said bandpass filters comprises a cylindrical sidewall terminated by opposed end walls defining a resonant cavity, each of said manifolds having a sidewall for connecting rigidly with various ones of said bandpass filters and, wherein, at a location of connection between a bandpass filter and a manifold there is electromagnetic coupling between the bandpass filter and the manifold via a slot extending through an end wall of the filter and the sidewall of the manifold.

4. A multiplexer according to claim 3 wherein, at the location of the connection between the bandpass filter and the manifold, the sidewall of the manifold serves as the end wall of the filter.

5. A multiplexer according to claim 3 wherein each of said filters includes a tuning element.

6. A multiplexer according to claim 5 wherein at least one of said filters is a dual mode filter having a first tuning screw for tuning a first mode of vibration of electromagnetic wave within the resonant cavity, a mode coupling screw for coupling electromagnetic energy between the first mode of vibration and a second mode of vibration, and a second tuning screw for tuning the second mode of vibration of electromagnetic wave within the resonant cavity, each of said screws extending through the sidewall of said filter.

7. A multiplexer according to claim 5 wherein at least one of said filters is a dual cavity filter having a transverse wall extending parallel to each of said end walls to divide said resonant cavity into a first cavity and a second cavity, said transverse wall having a slot for communicating electromagnetic energy between said first cavity and said second cavity, each of said first and said second cavities having a tuning screw for tuning a mode of vibration of electromagnetic wave within said cavity.

8. A multiplexer according to claim 2 further comprising a base for supporting each of said manifolds and each of said bandpass filters in a unitary structure.
